(19) United States
(12) Patent Application Publication
(10) Pub. No.: US 2026/0368287 A1
(43) Pub. Date: Nov. 19, 2026

(54) INFORMATION PROCESSING METHOD, INFORMATION PROCESSING SYSTEM, AND STORAGE MEDIUM

(71) Applicant: INTER-UNIVERSITY RESEARCH INSTITUTE CORPORATION RESEARCH ORGANIZATION OF INFORMATION AND SYSTEMS, Tokyo (JP)

(72) Inventors: Isao ECHIZEN, Tokyo (JP); Junichi YAMAGISHI, Tokyo (JP); Yusuke YASUDA, Tokyo (JP)

(73) Assignee: INTER-UNIVERSITY RESEARCH INSTITUTE CORPORATION RESEARCH ORGANIZATION OF INFORMATION AND SYSTEMS, Tokyo (JP)

(21) Appl. No.: 19/132,330

(22) PCT Filed: Nov. 15, 2023
(86) PCT No.: PCT/JP2023/041008

§ 371 Date: May 22, 2025

(30) Foreign Application Priority Data
Nov. 28, 2022 (JP) 2022-188818

(51) Int. Cl. G06F 21/10; G06V 20/00; G10L 25/69

(52) U.S. Cl. CPC G06F 21/106; G06V 20/95; G10L 25/69

(57) ABSTRACT

An information processing device includes: a media information acquiring unit to receive a posting request from an external terminal and acquire media information designated by the posting request; an output unit to output the media information to a storage device accessible from an inference device that performs authenticity determination indicating whether or not the media information is generated by AI; and a token transmitting unit to transmit to the external terminal an authenticity determination token for the external terminal to acquire a product of the authenticity determination on the media information generated by the inference device.

### TECHNICAL FIELD

The present invention relates to an information processing device, an information processing system, a program, and an information processing method.

### BACKGROUND ART

In recent years, by using artificial intelligence (AI), a still image or a moving image (hereinafter, a “still image” and a “moving image” are also collectively and simply referred to as an “image”) as if a real object was captured, a voice as if a voice actually uttered by a person was recorded, or a text expressed in a natural language as if described by a human has been generated.

Meanwhile, Patent Literature 1 describes a technique for blocking upload of an image suspected of being forged to a web server by performing forgery determination using a model created by machine learning when image data is to be uploaded to the web server for publication on the web, as a response to an image that may be so-called deep fake.

### CITATION LIST

### Patent Literature

Patent Literature 1: JP 2021-162965 A

### SUMMARY OF INVENTION

### Technical Problem

For an organization or an individual who handles media information, it is useful if a function (hereinafter, referred to as an “authenticity determination function”) of automatically recognizing whether a certain image, voice, or text (hereinafter, the “image”, the “voice”, and the “text” are also collectively referred to as “media information”) is an image obtained by capturing an actual object, recording of a voice of an actual person, a text described by a human, or the like (hereinafter referred to as “true information”), or media information (hereinafter, referred to as “fake information”) generated by AI can be used in a highly convenient method. This is because although it is conceivable that an organization or an individual develops a device or the like for implementing the authenticity determination function with high accuracy, for that purpose, advanced technology, knowledge, or equipment is required, and it is difficult for an organization or an individual not having the technology or the like to introduce the technology for implementing the authenticity determination function.

However, conventionally, there is a problem that the authenticity determination function cannot be provided to such an organization or individual (hereinafter referred to as a “user”) by a highly convenient method.

The technique described in Patent Literature 1 merely provides a function of blocking upload of an image suspected of being falsified at the time of uploading the image to a web server, and for example, the convenience is low since the use scene is limited, and the technique does not solve the above problem.

The present invention solves the above problems, and an object of the present invention is to obtain an information processing device, an information processing system, a program, and an information processing method for providing an authenticity determination function for media information to a user by a highly convenient method.

### Solution to Problem

An information processing device according to the present invention includes: a media information acquiring unit to receive a posting request from an external terminal and acquire media information designated by the posting request; an output unit to output the media information to a storage device accessible from an inference device that performs authenticity determination indicating whether or not the media information is generated by AI; and a token transmitting unit to transmit to the external terminal an authenticity determination token for the external terminal to acquire a product of the authenticity determination on the media information generated by the inference device.

### Advantageous Effects of Invention

An information processing device according to the present invention receives a posting request from an external terminal, acquires media information designated by the posting request, outputs the media information to a storage device accessible from an inference device that performs authenticity determination indicating whether or not the media information is generated by AI, and transmits to the external terminal an authenticity determination token for the external terminal to acquire a product of the authenticity determination on the media information generated by the inference device.

Thus, a user who desires to perform authenticity determination of certain media information causes the information processing device to acquire the media information using the external terminal, and thereby can obtain an authenticity determination token for the external terminal to acquire the product of the authenticity determination on the media information. Therefore, the information processing device according to the present invention can provide the authenticity determination function of the media information to the user by a highly convenient method.

### BRIEF DESCRIPTION OF DRAWINGS

FIG. 1 is a block diagram illustrating a configuration of an information processing system according to a first embodiment.

FIG. 2 is a block diagram illustrating hardware components that implement functions of an information processing device according to the first embodiment.

FIG. 3 is a diagram illustrating an example of an image in which an actual person is captured and an image generated by AI in a case where processed media information is an image.

FIG. 4 is a flowchart illustrating an information processing method according to the first embodiment.

FIG. 5 is a sequence diagram illustrating processing at the time of posting media information of the information processing system according to the first embodiment.

FIG. 6 is a sequence diagram illustrating processing at the time of authenticity determination of the information processing system according to the first embodiment.

FIG. 7 is a sequence diagram illustrating processing at the time of transmission and reception of a product of authenticity determination of the information processing system according to the first embodiment.

### DESCRIPTION OF EMBODIMENTS

### First Embodiment

### (Overall Configuration of Information Processing System)

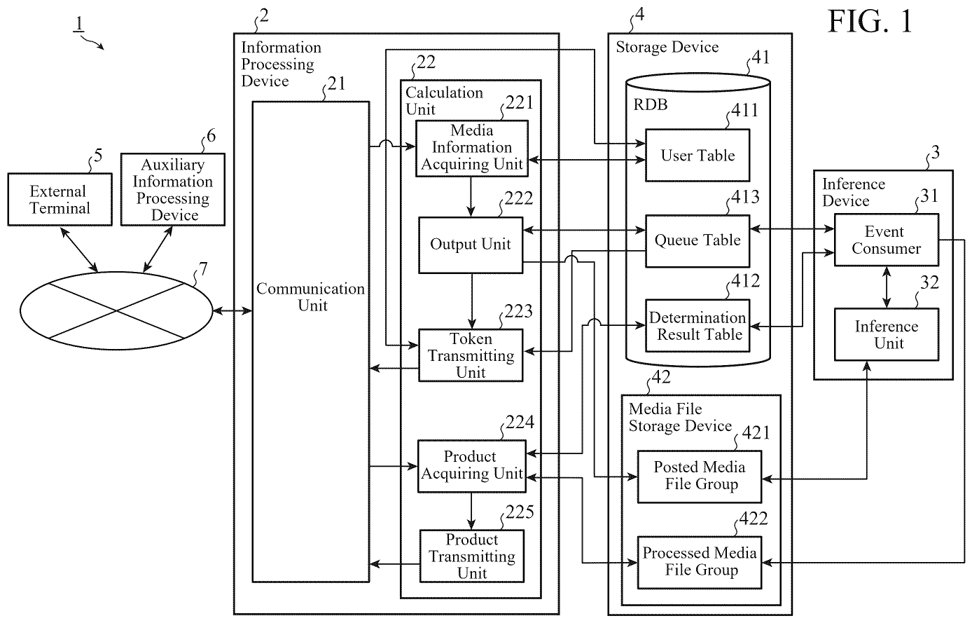

FIG. 1 is a block diagram illustrating a configuration of an information processing system 1 according to a first embodiment. In FIG. 1, an information processing system 1 is a system in which an information processing device 2, an external terminal 5, and an auxiliary information processing device 6 are connected to each other via a network 7, and the information processing device 2, an inference device 3, and a storage device 4 are connected to each other in an accessible manner. The network 7 is, for example, a telecommunication line including the Internet. Note that communication between the components is desirably performed using an encrypted communication protocol such as transport layer security (TLS).

The information processing device 2, the inference device 3, and the storage device 4 may be connected to each other via a telecommunication line such as the Internet, or any two or more devices may be configured by one device. In addition, each of the information processing device 2, the inference device 3, and the storage device 4 may be configured by a plurality of devices instead of a single device as long as the corresponding function is implemented. There may be one or a plurality of information processing devices 2, inference devices 3, storage devices 4, external terminals 5, and auxiliary information processing devices 6. FIG. 1 illustrates a case where there is one each.

In addition, the information processing system 1 may correspond to only one type or a plurality of types of media information (still image, moving image, voice, or text). In a case where the information processing system 1 corresponds to a plurality of types of media information, the information processing system 1 includes, for example, a plurality of inference devices 3 corresponding to the plurality of respective types, and the inference device 3 corresponding to the posted media information is used for authenticity determination.

The information processing system 1 only needs to include at least the information processing device 2, the inference device 3, the storage device 4, and the external terminal 5. The information processing system 1 in this case performs authenticity determination indicating whether or not the media information acquired from the external terminal 5 is generated by AI, and transmits a product of the authenticity determination to the external terminal 5.

Alternatively, the information processing system 1 may include at least the information processing device 2, the inference device 3, the storage device 4, the external terminal 5, and the auxiliary information processing device 6. The information processing system 1 in this case performs authenticity determination on the media information acquired from the external terminal 5, indicating whether or not the media information is generated by AI, and transmits a product of the authenticity determination to the auxiliary information processing device 6, and the auxiliary information processing device 6 transmits information corresponding to the product of the authenticity determination to the external terminal 5.

### (Outline of Information Processing Device)

The information processing device 2 receives a posting request from the external terminal 5, acquires media information designated by the posting request, outputs the media information to a storage device 4 accessible from an inference device 3 that performs authenticity determination indicating whether or not the media information is generated by AI, and transmits an authenticity determination token for the external terminal 5 to acquire a product of authenticity determination for the media information generated by the inference device 3 to the external terminal 5.

The information processing device 2 provides an authenticity determination API which is an application programming interface (API) for providing an authenticity determination function to the user via the external terminal 5. The information processing device 2 may be, for example, a Web API server that provides a Web API as the authenticity determination API. Hereinafter, it is assumed that the information processing device 2 is a Web API server.

The posting request acquired by the information processing device 2 is described as an HTTP request in accordance with, for example, hypertext transfer protocol (HTTP). In the present specification, “HTTP” also includes “hypertext transfer protocol secure (HTTPS)”.

The posting request is information requesting to post media information to be a target of authenticity determination to the information processing system 1. The posting request is described using, for example, a POST method.

The posting request includes information designating media information to be a target of authenticity determination. The information designating the media information to be the target of authenticity determination is, for example, the media information itself described in the posting request. For example, in a case where the posting request is described as an HTTP request, information designating media information to be the target of authenticity determination is described as data of the media information itself in the body of the HTTP request.

The information processing device 2 acquires the media information designated by the posting request, on the basis of the information for designating the media information to be the target of authenticity determination, described in the posting request.

When receiving the posting request and acquiring the media information designated by the posting request, the information processing device 2 outputs the media information to the storage device 4 accessible from the inference device 3.

Specifically, when acquiring the media information designated by the posting request, the information processing device 2 generates a file name (hereinafter referred to as “media information file name”) unique to the media information, and outputs the acquired media information and the generated media information file name to a media file storage device 42 (described later) included in the storage device 4.

Further, when acquiring the media information designated by the posting request, the information processing device 2 outputs authenticity determination event information indicating that authenticity determination of the media information designated by the posting request is to be performed to a relational database (RDB) 41 (described later) included in the storage device 4.

Hereinafter, processing of authenticity determination to be performed on the acquired media information is also referred to as an “authenticity determination event”. For example, when the information processing device 2 receives a new posting request and acquires media information designated by the posting request, a new authenticity determination event occurs. The information processing device 2 outputting the authenticity determination event information to the RDB 41 means notifying the RDB 41 that a new authenticity determination event has occurred. The authenticity determination event information includes, for example, a user ID (described later) of the user who has transmitted the posting request, generation request information (described later) for requesting generation of processed media information, and a media information file name of media information to be the target of authenticity determination.

Upon acquiring the authenticity determination event information, the RDB 41 generates an ID for the authenticity determination event information (hereinafter referred to as an “authenticity determination event ID”) as an integer value unique to the authenticity determination event information. The RDB 41 associates the generated authenticity determination event ID with the acquired authenticity determination event information, and registers them in a queue table 413 (described later) included in the RDB 41. Further, the RDB 41 outputs the generated authenticity determination event ID to the information processing device 2.

After outputting the media information to the storage device 4, the information processing device 2 transmits the authenticity determination token for the external terminal 5 to acquire the product of the authenticity determination for the media information generated by the inference device 3 to the external terminal 5.

For example, when outputting the media information and the authenticity determination event information to the storage device 4, the information processing device 2 uses the authenticity determination event ID acquired from the RDB 41 of the storage device 4 to generate a authenticity determination token unique to the processing of authenticity determination for the media information. The information processing device 2 transmits the generated authenticity determination token to the external terminal 5. At that time, the information processing device 2 describes the authenticity determination token in, for example, an HTTP response to the external terminal 5 in response to the posting request from the external terminal 5, and transmits the HTTP response.

In a case where the authenticity determination token is described in a request or the like transmitted from the external terminal 5 to the information processing device 2, the authenticity determination token may be any token as long as the media information that has become a target of authenticity determination can be specified by using the authenticity determination token, and also it is desirable that the integrity of the request or the like can be guaranteed.

From the viewpoint of information security, it is not preferable that a person different from a certain user can freely acquire a product of authenticity determination for media information posted by a posting request by the user. By using the authenticity determination token for guaranteeing the integrity, it is possible to prevent acquisition of a product of unauthorized authenticity determination when the authenticity determination token is falsified.

After the user operates the external terminal 5 to transmit the posting request to the information processing device 2, it is assumed that a relatively long time is usually required until authenticity determination by the inference device 3 is actually performed and the result of the authenticity determination is obtained. This is because, for example, it is generally assumed a case where authenticity determination is performed for a moving image having a large number of frames or a large capacity, or a case where many authenticity determination events are simultaneously present.

Nevertheless, if an authenticity determination result is included in a response such as an HTTP response from the information processing device 2 to the external terminal 5 to a posting request transmitted from the external terminal 5 to the information processing device 2, a relatively long time is required from the posting request to the response, and the user cannot determine whether or not the posting request is correctly received, which is not preferable.

On the other hand, as described above, in a case where the information processing device 2 describes the generated authenticity determination token in a response text such as an HTTP response and transmits the response text to the external terminal 5, the time from the posting request to the response becomes relatively short, and the user can confirm whether or not the posting request has been correctly received at an early stage, which is preferable. Then, the user can request a product of the authenticity determination by using the authenticity determination token at any timing desired by the user as long as it is a timing at which the product of the authenticity determination by the inference device 3 is obtained after confirming that the posting request is correctly received on the basis of the response text, and thus convenience for the user is high.

Details of the information processing device 2 will be described later.

### (Inference Device)

The inference device 3 performs authenticity determination indicating whether or not the media information is generated by AI.

The inference device 3 performs authenticity determination for the media information, and can generate an authenticity determination value or processed media information as a product of the authenticity determination. The authenticity determination value indicates a result of the authenticity determination by a numerical value or a character. The processed media information is obtained by adding information indicating a result of authenticity determination to the media information.

In a case where the media information is a moving image, the authenticity determination value is at least one of: a frame number of a frame generated by AI, an elapsed time indicating a moving image portion generated by AI, a moving image authenticity determination score indicating a result of authenticity determination by a numerical value, a threshold for distinguishing authenticity on the basis of the moving image authenticity determination score, coordinates indicating an image portion generated by AI in one frame, an authenticity determination result as the entire moving image indicated binarily, or indexes indicating a plurality of respective targets in a case where there is the plurality of targets for authenticity determination and the moving image authenticity determination score for each of the indexes.

The frame number of the frame generated by the AI is a frame number of a frame specified by the inference device 3 as a frame generated by the AI among the entire frames constituting the moving image.

As for the elapsed time indicating the moving image portion generated by the AI, the frame number of the frame specified by the inference device 3 as the frame generated by the AI as described above is indicated by the elapsed time from the beginning when the moving image is replayed from the beginning.

The moving image authenticity determination score indicating the result of the authenticity determination by a numerical value is indicated with a numerical value, a character in place of the numerical value, or the like output when the inference device 3 performs the processing of authenticity determination on the moving image, and is indicated by, for example, a numerical value of any of substantial consecutive values (numerical values between 0 and 1, or the like), a numerical value of any of the plurality of discrete values, or a character of any of the plurality of characters (letters such as S, A, B or C), or the like.

The threshold for distinguishing authenticity on the basis of the moving image authenticity determination score is a threshold for distinguishing the result of the authenticity determination into two values of true and false on the basis of the moving image authenticity determination score in a case where the above-described moving image authenticity determination score is obtained as the output performed by the inference device 3 in the processing of authenticity determination. For example, when the above-described output is obtained as a substantially continuous value between 0 and 1, the threshold can be set as, for example, 0.5, and when the output is equal to or less than 0.5, the result of the authenticity determination can be set as “true” indicating that it is not generated by AI, and when the output exceeds 0.5, the result of the authenticity determination can be set as “false” indicating that it is generated by the AI.

The coordinates indicating the image portion generated by the AI in one frame are one or more coordinates for specifying a region indicating the image portion generated by the AI in each portion in a certain frame. The coordinates indicating the image portion generated by the AI in one frame are, for example, at least two coordinates that can indicate a bounding box in a case where the image portion generated by the AI is specified by the inference device 3 as a region surrounded by the bounding box.

For example, in a case where an arrangement angle of the bounding box with respect to an outer shape of the frame is determined, the bounding box can be specified by using two coordinates indicating two vertices facing each other on one diagonal line among four vertices of the bounding box. Further, in a case where the arrangement angle of the bounding box with respect to the outer shape of the frame is not determined, the coordinates indicating the image portion generated by the AI in one frame can be three or more coordinates among the four vertices of the bounding box.

The authenticity determination result for the entire moving image indicated in a binary manner indicates a result of the authenticity determination as “true” or “false” for the entire moving image, among the entire frames constituting the moving image, on the basis of the presence or absence of a frame specified by the inference device 3 as a frame generated by the AI, the greater or less number of frames specified as frames generated by the AI, the above-described moving image authenticity determination score, the above-described threshold, and the like. The authenticity determination result is not limited to “true” or “false”, and may be indicated by other characters (for example, “real” or “fake”) or numerical values (for example, “0” or “1”).

An index indicating each target in a case where there is a plurality of targets of authenticity determination is, for example, a letter, a number, or a symbol added to distinguish each object in a case where there is a plurality of objects (for example, “faces of persons”) to be targets for authenticity determination in one moving image. The moving image authenticity determination score for each index indicates a result of authenticity determination by the inference device 3 for each target object to which the index is attached.

Further, in a case where the media information is a still image, the authenticity determination value is at least one of: a still image authenticity determination score indicating a result of authenticity determination by a numerical value, a threshold for distinguishing authenticity on the basis of the still image authenticity determination score, coordinates indicating an image portion generated by AI in the still image, an authenticity determination result of the entire still image indicated binarily, or indexes indicating a plurality of respective targets in a case where there is the plurality of targets for authenticity determination and the still image authenticity determination score for each of the indexes.

Since each authenticity determination value is similar to the case of the moving image, the description thereof is omitted.

Further, in a case where the media information is a voice, the authenticity determination value is at least one of: a voice authenticity determination score indicating a result of authenticity determination by a numerical value, a threshold for distinguishing authenticity on the basis of the voice authenticity determination score, a frequency domain of the voice generated by AI, or a time domain of the voice generated by AI.

Since the voice authenticity determination score indicating a result of authenticity determination by a numerical value and the threshold for distinguishing the authenticity on the basis of the voice authenticity determination score are similar to the moving image authenticity determination score and the threshold for the moving image, the description thereof will be omitted.

The frequency domain of the voice generated by AI is a numerical value indicating a frequency of a frequency component specified as a frequency component indicating the voice generated by the AI by the inference device 3 among one or more frequency components in expression of the frequency domain of the entire voice.

The time domain of the voice generated by AI is a numerical value indicating a time period specified as a time period indicating the voice generated by AI by the inference device 3 among one or more time periods in expression of the time domain of the entire voice. The numerical value indicating the time period is indicated by an elapsed time from the beginning when the voice is replayed from the beginning.

Further, in a case where the media information is a text, the authenticity determination value is at least one of: a text authenticity determination score indicating a result of authenticity determination by a numerical value, a threshold for distinguishing authenticity on the basis of the text authenticity determination score, or a position generated by AI in the text.

Since the text authenticity determination score indicating a result of authenticity determination by a numerical value and the threshold for distinguishing the authenticity on the basis of the text authenticity determination score are similar to the moving image authenticity determination score and the threshold for the moving image, the description thereof will be omitted.

The position generated by AI in the text is a number indicating a portion specified as the text generated by AI by the inference device 3 among all the texts.

For example, the position generated by the AI in the text is indicated by a plurality of numbers indicating from what character to what character from the beginning of the entire text, a plurality of numbers indicating from what character to what character in what line in a case where the entire text is displayed with the number of characters per specific line, or a plurality of numbers indicating from what character to what character in what page and what line in a case where the entire text is displayed with the number of characters per specific line and the number of lines per specific page.

Information indicating a result of authenticity determination added to the processed media information may be any information as long as the user viewing or listening the processed media information can recognize which part of the media information is fake information (information generated by AI) and which part of the information is true information (an image obtained by capturing an actual object, a recording of voice of an actual person, a text written by a human, or the like).

In a case where the media information is a moving image, the processed media information is, for example, obtained by adding a display of a bounding box to an object to be the target of authenticity determination in each frame constituting the moving image. The aspect of the added bounding box may be any aspect as long as the user visually recognizes that the object to be a target of authenticity determination in the bounding box is different between a case where the object is determined to be an image that is fake information and a case where the object is determined to be an image that is true information.

For example, the bounding box is added in such a manner that the object to be a target of authenticity determination in the bounding box is displayed in different colors in a case where the object is determined to be an image that is fake information and in a case where the object is determined to be an image that is true information (for example, the former is red and the latter is green). Further, for example, the bounding box is added in such a manner that the object to be a target of authenticity determination in the bounding box is displayed in different linear shapes in a case where the object is determined to be an image that is fake information and in a case where the object is determined to be an image that is true information (for example, the former is a solid line, and the latter is a broken line).

By obtaining the processed media information as a moving image, the user can visually recognize which part of the moving image is fake information or true information while replaying the moving image.

In a case where the media information is a still image, for example, the processed media information is obtained by adding a display of a bounding box to an object that is a target for authenticity determination in the still image. As in the case of the moving image, the aspect of the added bounding box may be any aspect as long as the user visually recognizes that the object to be a target of authenticity determination in the bounding box is different between a case where the object is determined to be an image that is fake information and a case where the object is determined to be an image that is true information.

FIG. 3 is a diagram illustrating an example of an image in which an actual person is captured and an image generated by AI in a case where the processed media information is an image.

FIG. 3 illustrates two types of images of persons. In FIG. 3, the image on the left side with characters “real” is an image in which an image 81A of a person is determined to be true information. A bounding box 8A is displayed around the image 81A. Further, in FIG. 3, the image on the right side with characters “fake” is an image in which an image 81B of a person is determined to be fake information. A bounding box 8B is displayed around the image 81B.

In FIG. 3, for example, the bounding box 8A is displayed by a green solid line, and the bounding box 8B is displayed by a red solid line.

By obtaining the processed media information as an image, the user can visually recognize whether an image as a determination target captured in the image is fake information or true information while visually recognizing the image.

In a case where the media information is a voice, the processed media information is, for example, an expression in the frequency domain of the voice or an expression in the time domain of the voice to which box-shaped information indicating that a certain portion of each domain is a voice as fake information is added.

Further, in a case where the media information is a voice, the processed media information may be, for example, display of the frequency component determined to be a voice as fake information in a color different from the display of other frequency components in the expression of the frequency domain of voice.

In addition, in a case where the media information is a voice, the processed media information may be, for example, display of the waveform of the time period determined to be a waveform of a voice as fake information in a color different from a waveform of a time period determined as a voice as true information in the expression in the time domain of the voice.

In a case where the media information is a text, the processed media information is, for example, box-shaped or linear information indicating that a certain portion in the text is a text as fake information.

In addition, in a case where the media information is a text, the processed media information may display, for example, characters of a portion of the text determined as fake information in a color different from characters of a portion of the text determined as true information.

Generation request information for requesting generation of the processed media information may be described in the posting request received by the information processing device 2 from the external terminal 5. Then, in a case where the generation request information is described in the posting request, the information processing device 2 outputs the authenticity determination event information including the generation request information to the storage device 4.

When the generation request information regarding the media information to be a target of authenticity determination is stored in the storage device 4, the inference device 3 generates at least the processed media information as a product of the authenticity determination for the media information, and outputs the generated processed media information to the storage device 4 to be stored therein. In addition, when the generation request information regarding the media information to be a target of authenticity determination is stored in the storage device 4, the inference device 3 may generate the authenticity determination value and the processed media information as a product of the authenticity determination by the inference device 3, and output the generated authenticity determination value and the processed media information to the storage device 4 to be stored therein.

On the other hand, when the generation request information regarding the media information to be a target of authenticity determination is not stored in the storage device 4, the inference device 3 generates at least the authenticity determination value as a product of the authenticity determination by the inference device 3, and outputs the generated authenticity determination value to the storage device 4 to be stored therein.

The inference device 3 includes, for example, an event consumer 31 and an inference unit 32.

The event consumer 31 refers to the queue table 413 (described later) in the RDB 41 (described later) constituting a part of the storage device 4, acquires an authenticity determination event ID indicating processing of authenticity determination to be performed next, acquires authenticity determination event information including a media information file name and the like associated with the authenticity determination event ID, and outputs at least the acquired media information file name to the inference unit 32.

Upon acquiring processing completion information indicating that the inference unit 32 has completed the processing of authenticity determination from the inference unit 32, the event consumer 31 adds information indicating completion such as a completion flag to the authenticity determination event ID for which the processing of authenticity determination has been completed, and outputs the information to the queue table 413.

Further, upon acquiring the authenticity determination value in addition to the processing completion information from the inference unit 32, the event consumer 31 outputs the acquired authenticity determination value together with the authenticity determination event ID to the RDB 41, and registers the authenticity determination value and the authenticity determination event ID in association with each other in a determination result table 412 (described later) included in the RDB 41.

Furthermore, when the inference unit 32 generates the processed media information in response to a request for generating the processed media information, the event consumer 31 generates a processed media information file name to be a file name when the processed media information is stored in the media file storage device 42 (described later), and outputs the processed media information acquired from the inference unit 32 and the generated processed media information file name to the media file storage device 42.

When the processed media information file name is generated, the event consumer 31 may further output the generated processed media information file name to the RDB 41 together with the authenticity determination event ID, and register the processed media information file name and the authenticity determination event ID in association with each other in the determination result table 412 included in the RDB 41.

When acquiring the media information file name from the event consumer 31, the inference unit 32 reads and acquires the media information having the media information file name from a posted media file group 421 (described later) in the media file storage device 42 (described later) constituting a part of the storage device 4. When acquiring the media information, the inference unit 32 performs authenticity determination.

Upon completing the processing of authenticity determination for the media information acquired from the posted media file group 421, the inference unit 32 outputs processing completion information indicating that the processing of authenticity determination for the media information has been completed to the event consumer 31. The inference unit 32 may transmit, for example, success/failure information indicating whether the processing of authenticity determination has succeeded or failed to the event consumer 31 as the processing completion information.

Further, when the authenticity determination event information acquired from the queue table 413 includes generation request information regarding media information to be a target of authenticity determination, the inference unit 32 generates the processed media information in the processing of authenticity determination for the media information acquired from the posted media file group 421.

When the processed media information is generated, the inference unit 32 outputs the generated processed media information to the storage device 4 via the event consumer 31, for example. The storage device 4 stores the acquired processed media information in a processed media file group 422 (described later) in the media file storage device 42 constituting a part of the storage device 4.

On the other hand, the inference unit 32 can generate the authenticity determination value in the processing of authenticity determination for the media information acquired from the posted media file group 421 regardless of the presence or absence of the generation request information. In particular, when the generation request information is not stored in the storage device 4, the inference unit 32 generates the authenticity determination value. When the inference unit 32 generates the authenticity determination value at the time of the processing of authenticity determination for the media information acquired from the posted media file group 421, when the processing of authenticity determination is completed, the inference unit outputs the generated authenticity determination value to the event consumer 31 in addition to the processing completion information.

The inference unit 32 performs authenticity determination of the media information using, for example, a machine-learned model. The model for performing authenticity determination may be any model that can perform the authenticity determination of the media information, and any model according to the type of the media information can be employed.

For example, in a case where the inference unit 32 performs authenticity determination of an image, an image recognition model learned using an EfficientNet model or a CapsuleNet model can be employed. In the case of performing the authenticity determination of the image, the inference unit 32 may detect an image portion to be a target of authenticity determination from the image as preprocessing, for example. For example, in a case where the inference unit 32 sets a human face as a target of authenticity determination, the inference unit 32 detects a portion in which a human face is captured in the image in the preprocessing. In addition, the inference unit 32 may detect a feature amount of an image portion after detecting the image portion to be a target of authenticity determination in the preprocessing. The inference unit 32 outputs an inference result of authenticity determination using the detected feature amount as an input to the machine-learned model.

In addition, for example, in a case where the inference unit 32 performs authenticity determination of the voice, a light convolution network (LCNN) model or the like can be employed.

Further, for example, in a case where the inference unit 32 performs authenticity determination of the text, a GLTR model or the like can be employed.

The information processing system 1 illustrated in FIG. 1 includes only one inference device 3, but the information processing system 1 may include two or more inference devices 3. In a case where the information processing system 1 includes two or more inference devices 3, the authenticity determination event ID and the authenticity determination event information may be registered in the queue table 413 in advance by allocating to each inference device 3, or may be registered without prior distinction as to which inference device 3 should process them.

For example, in a case where the latter registration form is employed, in each of the plurality of inference devices 3, when processing of a certain authenticity determination event is completed, the corresponding inference device 3 refers to the queue table 413, acquires the authenticity determination event information and the like of the authenticity determination event to be processed next among the authenticity determination events registered in the queue table 413, and processes the authenticity determination event. Further, in the latter case, the queue table 413 indicates in which inference device 3 the authenticity determination event being processed is acquired by the event consumer 31 and processed by the inference unit 32, and thus, for example, an event consumer ID that is an ID unique to each event consumer 31 is registered in association with the authenticity determination event ID or the like of the authenticity determination event being processed.

### (Storage Device)

The storage device 4 is accessible by the information processing device 2 and the inference device 3, and stores the media information acquired by the information processing device 2 on the basis of the posting request and output to the storage device 4. The media information stored in the storage device 4 has a media information file name assigned to the media information by the information processing device 2. The media information stored in the storage device 4 is a target of authenticity determination by the inference device 3, and is read by the inference device 3 on the basis of a request from the inference device 3 when the inference device 3 performs processing of authenticity determination.

Further, the storage device 4 stores a product of authenticity determination output from the inference device 3. The product of authenticity determination is the authenticity determination value or the processed media information.

Further, the storage device 4 stores information regarding management of the user, information for managing the order of the processing of authenticity determination, and the like.

The storage device 4 includes, for example, the RDB 41 and a media file storage device 42.

The RDB 41 manages users who use the information processing system 1, manages results of authenticity determination by the inference device 3, and manages the order of the processing of authenticity determination of media information by the inference device 3.

The RDB 41 includes, for example, a user table 411, a determination result table 412, and a queue table 413.

The user table 411 is a table for managing users who use the information processing system 1. In the user table 411, for example, a user name and a user ID are registered in association with each other. In addition, a unique public authenticity determination event ID seed for each user and a unique authenticity determination token password for each user can also be registered in the user table 411 in association with the user name and the like.

The user name is a name of the user. The user may be an organization or an individual. In a case where the user is an organization, for example, the user name is a name of the organization or a name of the user as a member of the organization managed by an administrator who manages use of the information processing system 1 in the organization. Further, in a case where the user is an individual who does not use the information processing system 1 through an organization, the user name is a name of the individual.

The user ID is an ID uniquely assigned to each user for identifying each user.

The public authenticity determination event ID seed and the authenticity determination token password will be described later.

The determination result table 412 is a table in which the authenticity determination value is registered among the products of the authenticity determination generated by the inference device 3 performing the authenticity determination. The authenticity determination value is registered, for example, in association with the authenticity determination event ID unique to the processing of authenticity determination for the media information that has become a target of authenticity determination when the authenticity determination value is generated. Further, when the processed media information is generated, the processed media information file name may be registered in the determination result table 412 in association with the authenticity determination event ID.

In the queue table 413, authenticity determination event IDs are stored in association with the authenticity determination event information in the order of the authenticity determination processing of the media information.

As described above, upon acquiring the media information designated by the posting request, the information processing device 2 outputs the authenticity determination event information to the RDB 41. Upon acquiring the authenticity determination event information, the RDB 41 generates an authenticity determination event ID for the authenticity determination event information, and registers the generated authenticity determination event ID and the acquired authenticity determination event information in the queue table 413 in association with each other.

In addition, the queue table 413 may include information regarding the processing state of the authenticity determination event indicated by the authenticity determination event ID and the like. The information regarding the processing state of the authenticity determination event includes, for example, information indicating whether each authenticity determination event is on standby, in processing, completed, or the like. Further, in a case where the information processing system 1 includes two or more inference devices 3, the information regarding the processing state of the authenticity determination event includes the event consumer ID of the event consumer 31 that is processing each authenticity determination event or has completed the processing.

In the queue table 413, for example, one or more authenticity determination event IDs are registered in such a manner that the processing of authenticity determination for the media information indicated by each authenticity determination event ID is performed in the order determined by a management program of the RDB 41 according to the first in first out (FIFO) method.

Alternatively, for example, one or more authenticity determination event IDs are registered in the queue table 413 in the order determined by the management program of the RDB 41 in such a manner that the processing of authenticity determination of the media information indicated by each authenticity determination event ID is performed in consideration of the processing status of the inference device 3. For example, the RDB 41 determines the order of the processing of authenticity determination and registers the authenticity determination event ID in the queue table 413 in such a manner that the processing of authenticity determination for the media information predicted to have a small capacity of the media information and a relatively short processing time by the inference device 3 is performed in preference to the processing predicted to have a large capacity of the media information and a relatively long processing time by the inference device 3.

Alternatively, for example, one or more authenticity determination event IDs may be registered in the queue table 413 in the order determined by the management program of the RDB 41 in such a manner that the processing of authenticity determination for the media information indicated by each authenticity determination event ID is performed in a priority order designated by the user.

Alternatively, in a case where there are a charging user who pays a usage fee and uses the authenticity determination function provided by the information processing system 1 and a free user who uses the authenticity determination function for free, one or more authenticity determination event IDs may be registered in the queue table 413 in the order determined by the management program of the RDB 41, for example, in such a manner that the processing of an authenticity determination event based on a posting request from the charging user is preferentially performed over the processing of an authenticity determination event based on a posting request from the free user.

The media file storage device 42 stores the media information acquired by the information processing device 2 and the processed media information generated by the inference device 3.

In the media file storage device 42, for example, the posted media file group 421 and the processed media file group 422 are separately stored.

The posted media file group 421 can store one or more pieces of media information acquired by the information processing device 2. The media information stored in the posted media file group 421 has a media information file name.

In the processed media file group 422, one or more pieces of processed media information generated by the inference device 3 can be stored. The processed media information stored in the processed media file group 422 has a processed media information file name.

### (External Terminal)

The external terminal 5 is a terminal used by a user who uses the authenticity determination function for media information via the authenticity determination API provided by the information processing device 2. The external terminal 5 is a terminal device capable of communicating with at least the information processing device 2 via the network 7, and is, for example, a smartphone, a tablet terminal, or a personal computer (PC).

The information processing system 1 may include a plurality of external terminals 5. FIG. 1 illustrates only one external terminal 5.

### (Auxiliary Information Processing Device)

The auxiliary information processing device 6 is a device that acquires a product of authenticity determination from the information processing device 2, generates information corresponding to the product of authenticity determination, and transmits the information to the external terminal 5. The auxiliary information processing device 6 is a device capable of communicating with at least the information processing device 2 and the external terminal 5 via the network 7, and is, for example, a server computer.

The information processing system 1 may include a plurality of auxiliary information processing devices 6. FIG. 1 illustrates only one auxiliary information processing device 6.

The information corresponding to the product of authenticity determination is information generated using the product of authenticity determination acquired from the information processing device 2, and may be any information as long as it is information for conveying relevant contents regarding a result of authenticity determination to the user through the external terminal 5.

For example, in a case where a target of authenticity determination is a moving image and an authenticity determination value, which is a product of authenticity determination, indicates the number of frames generated by AI among the frames of the moving image, the auxiliary information processing device 6 generates information displaying the total number of frames of the moving image and the total number of frames generated by AI as information corresponding to the product of authenticity determination.

Further, for example, in a case where a target of authenticity determination is a moving image and a product of authenticity determination is processed media information, the auxiliary information processing device 6 generates media information obtained by extracting only a frame including an image generated by AI from the moving image as information corresponding to the product of authenticity determination.

Further, for example, in a case where the subject of the authenticity determination is a voice and the authenticity determination value, which is a product of the authenticity determination, indicates frequency components by AI in the frequency domain of the voice, the auxiliary information processing device 6 generates information displaying the total number of frequency components of the voice and the total number of frequency components generated by AI as information corresponding to the product of authenticity determination.

Further, for example, in a case where the target of authenticity determination is a voice and a product of authenticity determination is processed media information, the auxiliary information processing device 6 generates media information obtained by extracting only frequency components generated by AI from the voice which is the processed media information, as information corresponding to the product of authenticity determination.

Further, for example, in a case where the target of authenticity determination is a text and the authenticity determination value, which is a product of the authenticity determination, indicates a position of a portion of the text generated by AI, the auxiliary information processing device 6 generates information displaying the total number of characters included in the text and the total number of characters generated by AI as information corresponding to the product of authenticity determination.

Further, for example, in a case where the target of authenticity determination is a text and a product of the authenticity determination is the processed media information, the auxiliary information processing device 6 generates media information in which only a text portion generated by AI is extracted from the text which is the processed media information, as information corresponding to the product of authenticity determination.

### (Details of Information Processing Device)

The information processing device 2 will be described in more detail. As illustrated in FIG. 1, the information processing device 2 includes a communication unit 21 and a calculation unit 22.

The communication unit 21 communicates with the external terminal 5 or the auxiliary information processing device 6 via the network 7. For example, the communication unit 21 can communicate with the external terminal 5 capable of mobile communication by a communication system such as LTE, 3G, 4G, or 5G via the network 7.

The calculation unit 22 controls the overall operation of the information processing device 2. The calculation unit 22 includes a media information acquiring unit 221, an output unit 222, a token transmitting unit 223, a product acquiring unit 224, and a product transmitting unit 225. The calculation unit 22 executes an authenticity determination API program, thereby implementing the functions of the media information acquiring unit 221, the output unit 222, the token transmitting unit 223, the product acquiring unit 224, and the product transmitting unit 225.

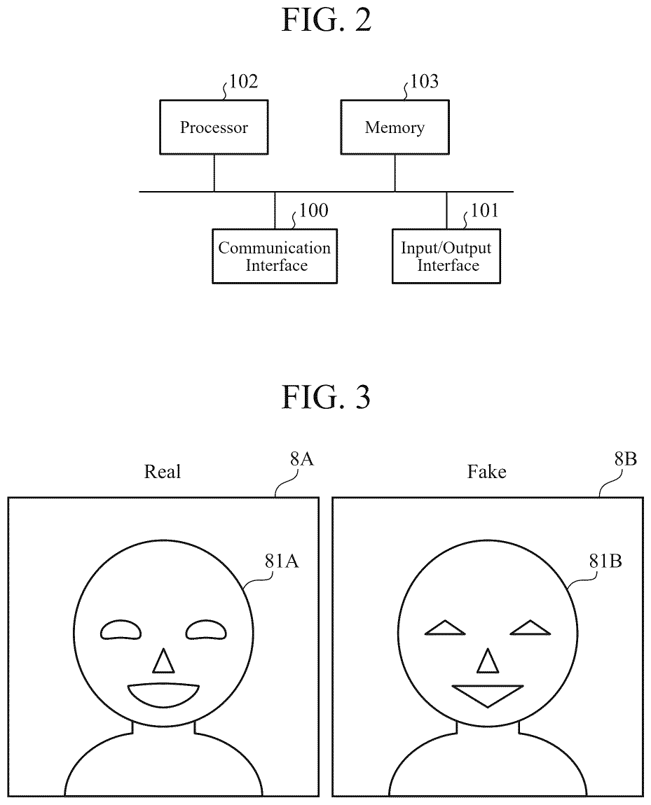

FIG. 2 is a block diagram illustrating hardware components that implement the functions of the information processing device 2. For example, the information processing device 2 includes a communication interface 100, an input/output interface 101, a processor 102, and a memory 103 as hardware components. Each of the functions of the media information acquiring unit 221, the output unit 222, the token transmitting unit 223, the product acquiring unit 224, and the product transmitting unit 225 included in the information processing device 2 are implemented by executing the authenticity determination API program in these hardware configurations.

The communication interface 100 outputs data received from various external devices via the network 7 to the processor 102, and transmits data generated by the processor 102 to the external terminal 5 via the network 7. The processor 102 reads and writes data from and in a storage unit (not illustrated) such as a hard disk drive (HDD) or a solid state drive (SSD) via the input/output interface 101.

The storage unit stores the authenticity determination API program for implementing each function of the media information acquiring unit 221, the output unit 222, the token transmitting unit 223, the product acquiring unit 224, and the product transmitting unit 225. Further, information used for arithmetic processing of the calculation unit 22 is stored in the storage unit.

The processor 102 reads the program stored in the above-described storage unit (not illustrated) via the input/output interface 101, loads the program into the memory 103, and executes the program loaded into the memory 103. Thus, the processor 102 implements the functions of the media information acquiring unit 221, the output unit 222, the token transmitting unit 223, the product acquiring unit 224, and the product transmitting unit 225.

The memory 103 is, for example, a random access memory (RAM).

### (Media Information Acquiring Unit)

The media information acquiring unit 221 receives a posting request from the external terminal 5, and acquires media information designated by the posting request. Upon receiving the posting request from the external terminal 5 via the communication unit 21, the media information acquiring unit 221 may first confirm whether the posting request has been transmitted by a valid user of the information processing system 1. For the confirmation, in the posting request, information for designating media information to be a target of authenticity determination may be described, and an API token given to the user who transmits the posting request may be described.

Upon receiving the posting request, the media information acquiring unit 221 accesses the user table 411 in the RDB 41, and performs authentication processing using the API token by using information or the like in the user table 411 associated with the user ID or the like obtained from the API token described in the posting request. As the authentication processing using the API token, any method applying a known authentication method can be employed. When authentication is performed using the API token, the media information acquiring unit 221 determines that the posting request describing the API token has been transmitted by a valid user of the information processing system 1.

Note that the first embodiment will be described assuming that authentication using the API token is performed every time the information processing device 2 receives a request such as a posting request, but authentication using the API token is not essential and may be omitted. In this case, the API token is not described in a request such as a posting request.

The media information acquiring unit 221 performs authentication using the API token, and acquires media information designated by the posting request on the basis of information for designating media information to be a target of authenticity determination, which is described in the posting request.

Upon acquiring the media information designated by the posting request, the media information acquiring unit 221 outputs at least the acquired media information and authenticity determination event information to the output unit 222. Further, in a case where the generation request information is described in the posting request, the media information acquiring unit 221 includes the generation request information in the authenticity determination event information and outputs the same to the output unit 222.

### (Output Unit)

The output unit 222 outputs the media information to the storage device 4 accessible from the inference device 3 that performs authenticity determination indicating whether or not the media information is generated by AI.

Upon acquiring the media information and the authenticity determination event information from the media information acquiring unit 221, the output unit 222 generates a media information file name unique to the media information, assigns the media information file name to the media information, outputs the media information file name to the media file storage device 42 included in the storage device 4, and adds and stores the media information file name as one file in the posted media file group 421 stored in the media file storage device 42.

Further, when acquiring the media information and the authenticity determination event information from the media information acquiring unit 221, the output unit 222 outputs the authenticity determination event information to the RDB 41. As described above, upon acquiring the authenticity determination event information, the RDB 41 generates the authenticity determination event ID, and registers the generated authenticity determination event ID and the authenticity determination event information in the queue table 413 in association with each other. Further, the RDB 41 outputs the generated authenticity determination event ID to the output unit 222.

When the output of the media information to the media file storage device 42, the output of the authenticity determination event information to the RDB 41, and the acquisition of the authenticity determination event ID from the RDB 41 are finished, the output unit 222 outputs the authenticity determination event ID and the authenticity determination event information to the token transmitting unit 223.

### (Token Transmitting Unit)

The token transmitting unit 223 transmits, to the external terminal 5, an authenticity determination token for the external terminal 5 to acquire a product of authenticity determination for the media information generated by the inference device 3.

Upon acquiring the authenticity determination event ID and the authenticity determination event information from the output unit 222, the token transmitting unit 223 generates the authenticity determination token.

In a case where the authenticity determination token generated by the token transmitting unit 223 is described in a request or the like transmitted from the external terminal 5 to the information processing device 2, the authenticity determination token may be used as long as the media information that has become a target of authenticity determination can be specified and integrity of the request or the like can be guaranteed, and the token transmitting unit 223 can generate such authenticity determination token by any method. For example, the token transmitting unit 223 generates the authenticity determination token using the authenticity determination event ID acquired from the output unit 222 and the public authenticity determination event ID seed and the authenticity determination token password acquired from the user table 411.

The token transmitting unit 223 can acquire the public authenticity determination event ID seed and the authenticity determination token password registered in association with the user ID or the like obtained from the API token from the user table 411 using the API token acquired from the output unit 222.

A specific example of generating the authenticity determination token will be described later.

Upon generating the authenticity determination token, the token transmitting unit 223 transmits the generated authenticity determination token to the external terminal 5 via the communication unit 21. The token transmitting unit 223 describes the authenticity determination token in, for example, an HTTP response to the external terminal 5 in response to the posting request from the external terminal 5, and transmits the HTTP response.

### (Product Acquiring Unit)

The product acquiring unit 224 receives a product request describing the authenticity determination token from the external terminal 5, and acquires a product of the authenticity determination identified by the authenticity determination token from the storage device 4.

The product acquiring unit 224 can acquire an authenticity determination value indicating a result of the authenticity determination by a numerical value or a character as the product of the authenticity determination. Further, the product acquiring unit 224 can acquire the processed media information in which the information indicating the result of the authenticity determination is added to the media information, as the product of the authenticity determination.

Specifically, the product acquiring unit 224 receives a product request transmitted from the external terminal 5 to the information processing device 2 via the communication unit 21, and acquires the authenticity determination value or the processed media information as the product of the authenticity determination according to the description of the product request.

As described above, when the generation request information regarding the media information to be a target of authenticity determination is stored in the storage device 4, the inference device 3 generates the processed media information as a product of the authenticity determination for the media information, and outputs the generated processed media information in the storage device 4 to be stored therein.

Therefore, in order to describe the above-described end point in the product request when the user operates the external terminal 5 to request acquisition of the processed media information, transmit the product request to the information processing device 2, and acquire the processed media information as a product of the authenticity determination, the user needs to describe the generation request information in the posting request in advance.

As described above, when the generation request information for requesting generation of the processed media information is described in the posting request, the output unit 222 outputs the authenticity determination event information including the generation request information to the storage device 4 together with the media information. Then, upon receiving the product request in which the authenticity determination token and a transmission request of the processed media information are described from the external terminal 5, the product acquiring unit 224 acquires the processed media information as the product of the authenticity determination.

Specifically, the product acquiring unit 224 acquires the processed media information from the processed media file group 422. The product acquiring unit 224 can specify the processed media information to be acquired using the authenticity determination token. A specific example of specifying the processed media information using the authenticity determination token will be described later.

On the other hand, the inference device 3 can generate the authenticity determination value as a product of the authenticity determination regardless of the presence or absence of the generation request information, and output and store the generated authenticity determination value in the storage device 4. Then, upon receiving the product request in which the authenticity determination token and the transmission request of the authenticity determination value are described from the external terminal 5, the product acquiring unit 224 acquires the authenticity determination value as the product of the authenticity determination.

The product request is a request for transmission of the authenticity determination value or the processed media information, as a product of the authenticity determination stored in the storage device 4, and is described according to, for example, HTTP. Specifically, the product request is described using, for example, the GET method. In the product request, in addition to the authenticity determination token, an API token may also be described. In a case where the API token is described in the product request, when acquiring the product request from the external terminal 5, the product acquiring unit 224 performs authentication processing of the user on the basis of the API token, and then acquires a product of authenticity determination.

As described above, the product of the authenticity determination is the authenticity determination value or the processed media information. In order to enable the user to select which product to acquire, the end point described in the product request in a case where transmission of the authenticity determination value is requested and the end point described in the product request in a case where transmission of the processed media information is requested are both common in that they are described by a uniform resource identifier (URI) and the API token and the authenticity determination token are described at the end, for example, but the descriptions of the entire end points are set to be different from each other. The description manners of both end points are preset and known to the user.

Upon acquiring the product of authenticity determination from the storage device 4, the product acquiring unit 224 outputs the acquired product of authenticity determination to the product transmitting unit 225.

### (Product Transmitting Unit)

The product transmitting unit 225 transmits the product of authenticity determination to the external terminal 5.

Specifically, when acquiring the product of the authenticity determination from the product acquiring unit 224, the product transmitting unit 225 transmits the acquired product of the authenticity determination to the external terminal 5 via the communication unit 21.

### (Information Processing Method)

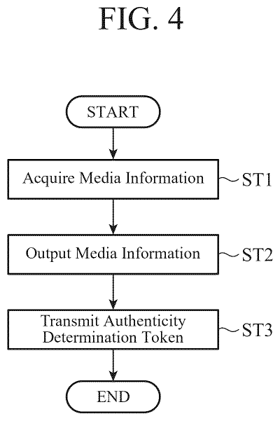

FIG. 4 is a flowchart illustrating an information processing method according to the first embodiment.

Prior to the processing of FIG. 4, for example, the administrator who manages the use of the information processing system 1 by an individual user who is a member of an organization such as a company first uses a management API provided for managing the individual user who uses the authenticity determination API to acquire an API token unique to each individual user, and provides the API token to the corresponding individual user. The management API may be provided by the information processing device 2 or may be provided by another device (not illustrated). In addition, prior to the processing of FIG. 4, for example, a person who desires to use the information processing system 1 as an individual without going through an organization can acquire the API token for the person himself/herself by using a similar management API.

When the user desires to perform authenticity determination of desired media information using the authenticity determination function provided by the information processing system 1, the user operates the external terminal 5 to transmit a posting request to the information processing device 2.

The media information acquiring unit 221 receives the posting request from the external terminal, and acquires media information designated by the posting request (step ST1).

The output unit 222 outputs the media information to the storage device 4 accessible by the inference device 3 that performs authenticity determination on the media information (step ST2).

The token transmitting unit 223 transmits the authenticity determination token for the external terminal 5 to acquire the product of the authenticity determination for the media information generated by the inference device 3 to the external terminal 5 (step ST3).

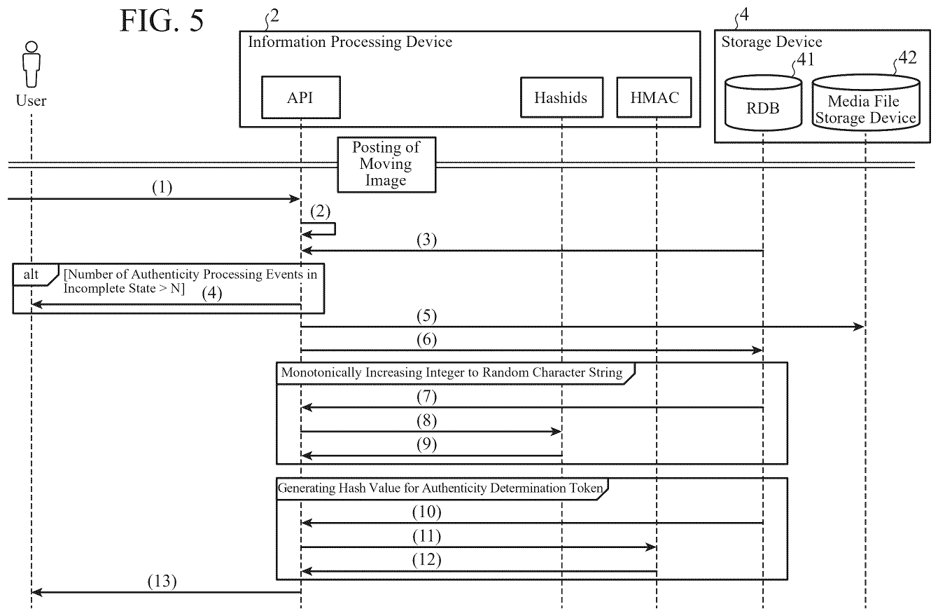

FIG. 5 is a sequence diagram illustrating processing at the time of media information posting of the information processing system according to the first embodiment. FIG. 5 illustrates a more specific example of processing at the time of media information posting in the information processing system 1.

In FIG. 5, “Hashids” is a well-known open source library used by the information processing device 2. By using the Hashids, the information processing device 2 can obtain a random character string by converting the original data using, for example, a character string having any length or the like. In addition, in Hashids, the obtained random character string can be decoded using the character string used at the time of conversion of the original data to obtain the original data.

Further, in FIG. 5, an “HMAC” (Hash based Message Authentication Code) is a well-known technology for message authentication used by the information processing device 2. The HMAC uses a hash value obtained from both a secret key and original data such as any character string to be a target of authentication.

Further, in FIG. 5, “user” indicates a user who uses the external terminal 5. Therefore, information is actually transmitted and received between the external terminal 5 and the information processing device 2 or the storage device 4.

Hereinafter, each of the processing steps (1) to (13) in FIG. 5 will be described in order.
(1) The user (external terminal 5) transmits, to the API of the information processing device 2, a posting request in which an API token and information for designating media information to be a target of authenticity determination are described.

The API (for example, the media information acquiring unit 221) of the information processing device 2 acquires the API token described in the posting request, and acquires the media information on the basis of the information for designating the media information to be a target of authenticity determination described in the posting request. The API token is a token required when each user performs authenticity determination for desired media information using the information processing system 1. When the user transmits a request such as a posting request using the external terminal 5, the API token is required to be described in the request in order to prove that the user is a valid user.

For example, when information regarding the user such as a user name is registered in the user table 411 of the RDB 41, the API token is generated by a management API (not illustrated) or the like and is notified to the user.
(2) The API (for example, the media information acquiring unit 221) of the information processing device 2 performs authentication processing of the user on the basis of the API token. As the authentication processing using the API token, any method applying a known authentication method can be employed. For example, in the authentication processing, the API of the information processing device 2 can obtain information such as a user ID from the API token. The API of the information processing device 2 can perform the authentication processing of the user by using the information such as a user ID obtained from the API token and the information registered in the user table 411 of the RDB 41 in association with the information such as the user ID.

Note that an expiration date may be set to the API token. In a case where the API token is provided with an expiration date, the API of the information processing device 2 also determines whether or not the API token has passed the expiration date, and when it is determined that the expiration date has passed, a response indicating a processing error to that effect is transmitted to the user (external terminal 5).
(3) The RDB 41 of the storage device 4 outputs the number of authenticity determination events in an incomplete state to the API of the information processing device 2.
(4) In a case where the number of authenticity determination events in the incomplete state is larger than the predetermined number N, the API (for example, the output unit 222) of the information processing device 2 transmits a response indicating a processing error to the user (external terminal 5) as a response to the posting request in consideration of the processing load by the inference device 3. In addition, the API of the information processing device 2 may further determine (hereinafter referred to as “format determination”) whether or not the media information is provided in a format capable of performing authenticity determination processing. When the API of the information processing device 2 determines that the media information is not provided in the format capable of performing the authenticity determination processing, the API transmits a response indicating a processing error indicating that the media information is not provided in the format capable of performing the authenticity determination processing to the user (external terminal 5).
(5) In a case where the number of authenticity determination events in the incomplete state is equal to or less than a predetermined number N, and in a case where format determination is performed, in addition, in a case where the media information is provided in a format capable of performing the authenticity determination processing, the API (for example, the output unit 222) of the information processing device 2 generates a media information file name unique to the media information acquired as a target for authenticity determination, and outputs the media information and the media information file name to the media file storage device 42 of the storage device 4. The media file storage device 42 includes and stores the acquired media information with a media information file name in the posted media file group 421.
(6) In a case where the number of authenticity determination events in the incomplete state is equal to or less than a predetermined number N, and in a case where format determination is performed, the API (for example, the output unit 222) of the information processing device 2 further outputs, to the RDB 41, authenticity determination event information indicating that new media information to be a target of authenticity determination has been acquired in a case where the media information is provided in a format capable of performing the authenticity determination processing. The RDB 41 generates an authenticity determination event ID, which is an integer value unique to the authenticity determination event information, and outputs the authenticity determination event ID to the API of the information processing device 2. The authenticity determination event ID is generated as a monotonically increasing integer.
(7) The API (for example, the token transmitting unit 223) of the information processing device 2 acquires the public authenticity determination event ID seed associated with the user ID or the like obtained from the API token from the RDB 41 of the storage device 4. The public authenticity determination event ID seed is a character string having any length set as a unique value for each user. This character string of any length may include letters, numbers, or symbols. For example, when information regarding the user such as a user name is registered in the user table 411 of the RDB 41, the public authenticity determination event ID seed is generated by the RDB 41 or the like, and is registered in the user table 411 in association with the information regarding the user.
(8) The API (for example, the token transmitting unit 223) of the information processing device 2 sets the public authenticity determination event ID seed to Hashids as a character string to be used when the authenticity determination event ID is converted to generate a random character string. The public authenticity determination event ID seed has a so-called salt role in Hashids.
(9) When a random character string is generated, Hashids returns the random character string to the API of the information processing device 2 as a public authenticity determination event ID.
(10) The API (for example, the token transmitting unit 223) of the information processing device 2 acquires the authenticity determination token password associated with the user ID and the like obtained from the API token from the RDB 41 of the storage device 4. The authenticity determination token password is any character string set as a unique value for each user. This any character string may include a letter, a number, or a symbol. For example, the authenticity determination token password is generated by the RDB 41 or the like when information regarding the user such as the user name is registered in the user table 411 of the RDB 41, is associated with the information regarding the user, is associated with the user ID, and is registered in the user table 411.
(11) The API (for example, the token transmitting unit 223) of the information processing device 2 sets the authenticity determination token password and the public authenticity determination event ID to an HMAC.

The authenticity determination token password has a role of a secret key in the HMAC, and the public authenticity determination event ID has a role of original data in the HMAC. However, in the information processing system 1, the HMAC is used for ensuring the integrity of the authenticity determination token included in the product request transmitted from the user (external terminal 5) for acquiring the product of the authenticity determination, in other words, for confirming whether or not the authenticity determination token has been tampered with. Then, as described later, the authenticity determination token is transmitted to the user (external terminal 5) as including a first hash value generated by the information processing device 2 itself using the public authenticity determination event ID and the authenticity determination token password and the public authenticity determination event ID. Therefore, unlike a secret key in a general HMAC, the authenticity determination token password is not used for hashing some transmission information on the user (external terminal 5) side, and thus is not shared with the user (external terminal 5).

Note that, for example, when the token transmitting unit 223 performs the processing of the processing steps (7) to (11), the token transmitting unit 223 needs to use the registration information in the user table 411, but a connection line between the token transmitting unit 223 and the user table 411 is omitted in FIG. 1.
(12) The HMAC generates the first hash value by hashing the public authenticity determination event ID using the authenticity determination token password and returns the first hash value to the API of the information processing device 2.
(13) The API (for example, the token transmitting unit 223) of the information processing device 2 transmits the authenticity determination token including the public authenticity determination event ID and the first hash value to the user (the external terminal 5).

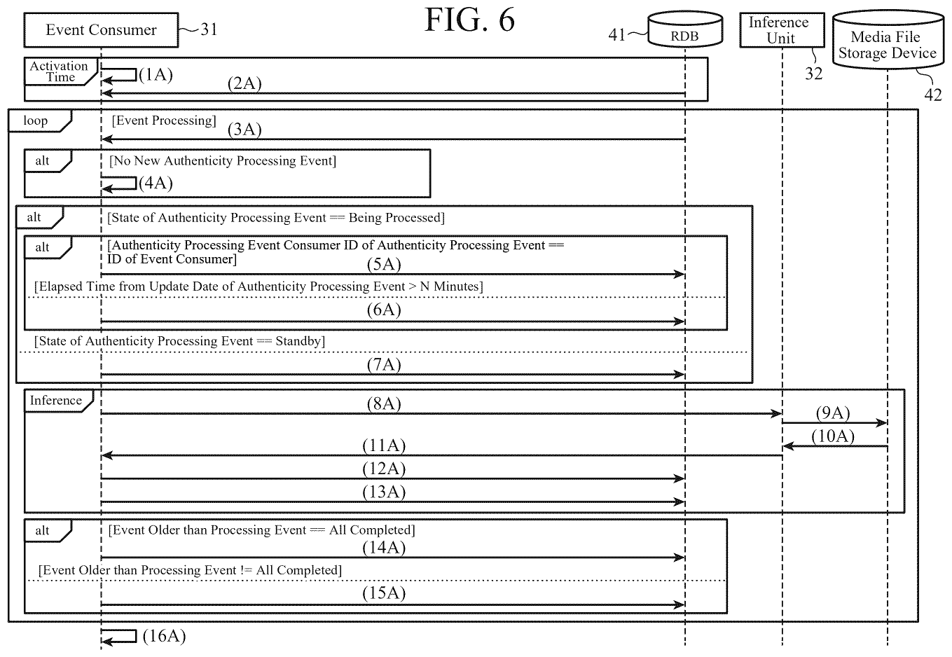

FIG. 6 is a sequence diagram illustrating processing at the time of authenticity determination of the information processing system according to the first embodiment. FIG. 6 illustrates a more specific example of the processing at the time of authenticity determination in the information processing system 1. FIG. 6 illustrates processing in the event consumer 31 included in one inference device 3 among a plurality of inference devices 3 in a case where the information processing system 1 includes the plurality of inference devices 3.

Hereinafter, the processing steps (1A) to (17A) in FIG. 6 will be described in order.
(1A) Upon activation of the event consumers 31, each event consumer 31 is assigned an event consumer ID, which is a unique ID.
(2A) The event consumer 31 acquires a latest continuous completion authenticity determination event ID, which is the authenticity determination event ID of the latest continuous completion authenticity determination event, from the RDB 41 of the storage device 4. More specifically, the event consumer 31 acquires the latest continuous completion authenticity determination event ID from the queue table 413 in the RDB 41. The latest continuous completion authenticity determination event ID indicates that there is no authenticity determination event older than the authenticity determination event indicated by the ID.
(3A) The event consumer 31 acquires a predetermined number of pieces of the authenticity determination event information of the incomplete authenticity determination events newer than the latest continuous completion authenticity determination event ID from the RDB 41 of the storage device 4. More specifically, the event consumer 31 acquires the authenticity determination event information of the above-described incomplete authenticity determination event from the queue table 413 in the RDB 41. The incomplete authenticity determination event is an authenticity determination event that is being processed or on standby.
(4A) When the event consumer 31 determines that there is no new incomplete authenticity determination event, then the event consumer 31 returns the processing to processing step (2A).
(5A) When determining that there is a new incomplete authenticity determination event, the event consumer 31 determines whether or not each authenticity determination event is currently processed, and when the authenticity determination event as a target of determination of whether or not it is being processed is currently being processed, the event consumer 31 refers to the event consumer ID that is processing the authenticity determination event and determines whether or not the event consumer ID is its own event consumer ID. Then, in a case where the event consumer ID is its own event consumer ID, the event consumer 31 outputs, to the RDB 41 of the storage device 4, information indicating that the state of the authenticity determination event is being processed, and its own event consumer ID for indicating that the event consumer that is processing is the event consumer itself.
(6A) In the determination of whether or not the event consumer ID in the processing step (5A) is its own event consumer ID, when the event consumer ID is determined not to be its own event consumer ID, then the event consumer 31 determines whether or not a predetermined time (N minutes) or more has elapsed from an update date (update time) of the state of the authenticity determination event being processed, and when it is determined that the predetermined time or more has elapsed, the event consumer moves the authenticity determination event from the event consumer (not itself) that is processing and processes the authenticity determination event by itself. Then, the event consumer 31 outputs, to the RDB 41 of the storage device 4, information indicating that the state of the authenticity determination event is being processed, and its own event consumer ID for indicating that the event consumer that is processing has been moved to the event consumer itself.
(7A) In the processing step (5A), in a case where the authenticity determination event for which it is determined whether or not it is being processed is on standby, the event consumer 31 determines that the oldest authenticity determination event among waiting authenticity determination events is to be processed by itself. Then, the event consumer 31 outputs, to the RDB 41 of the storage device 4, information indicating that the state of the authenticity determination event that the event consumer has decided to process is being processed, and its own event consumer ID for indicating that the event consumer that is processing is the event consumer itself.
(8A) The event consumer 31 outputs the media information file name of the media information to be a target of authenticity determination to the inference unit 32. When the authenticity determination event information includes the generation request information, that is, when generation of the processed media information is requested, the event consumer 31 may set a temporary storage path in a storage unit (not illustrated) included in the inference unit 32 for temporarily storing the processed media information and output information indicating the temporary storage path to the inference unit 32 together with the media information file name.
(9A) Upon acquiring the media information file name from the event consumer 31, the inference unit 32 requests the media file storage device 42 for media information whose file name is the media information file name.
(10A) The inference unit 32 acquires media information whose file name is a media information file name from the media file storage device 42, and performs authenticity determination on the acquired media information. In a case where generation of the processed media information is requested, the inference unit 32 generates the processed media information and stores the generated processed media information in the temporary storage path.
(11A) The inference unit 32 transmits information (processing completion information) indicating that the processing of authenticity determination is completed and the authenticity determination value to the event consumer 31.

The inference unit 32 may transmit, for example, success/failure information indicating whether the processing of authenticity determination has succeeded or failed to the event consumer 31 as the processing completion information. When transmitting the success/failure information indicating that the processing of authenticity determination has failed to the event consumer 31, the inference unit 32 does not transmit the authenticity determination value to the event consumer 31.

When the success/failure information acquired from the inference unit 32 indicates that the processing of authenticity determination has failed, the event consumer 31 returns the processing to the processing step (2A).

On the other hand, in a case where the inference unit 32 transmits the success/failure information indicating that the processing of authenticity determination has succeeded to the event consumer 31, the inference unit additionally transmits the authenticity determination value to the event consumer 31. In a case where the success/failure information acquired from the inference unit 32 indicates that the processing of authenticity determination has succeeded, the event consumer 31 proceeds with the processing to the processing step (12A).
(12A) Upon acquiring the processing completion information (success/failure information) and the authenticity determination value, the event consumer 31 outputs the acquired authenticity determination value to the RDB 41 together with the authenticity determination event ID. Upon acquiring the authenticity determination value and the authenticity determination event ID, the RDB 41 associates and registers the authenticity determination value and the authenticity determination event ID in the determination result table 412.
(13A) When the inference unit 32 generates the processed media information in response to a request for generating the processed media information, the event consumer 31 generates a processed media information file name. Further, the event consumer 31 acquires the processed media information stored in the temporary storage path from the inference unit 32, and outputs the acquired processed media information and the generated processed media information file name to the media file storage device 42.

The media file storage device 42 includes and stores the acquired processed media information with the processed media information file name in the processed media file group 422.

In addition, the event consumer 31 may further output the generated processed media information file name to the RDB 41 together with the authenticity determination event ID. Upon acquiring the processed media information file name and the authenticity determination event ID, the RDB 41 registers the processed media information file name in the determination result table 412 in association with the authenticity determination event ID.

In the processing step (13A), the event consumer 31 may set a limit (hereinafter referred to as “expiration date”) to the period during which the processed media information is stored in the storage device 4. When the expiration date is set, the processed media information that has passed the expiration date is deleted from the storage device 4. Setting of the expiration date is useful, for example, when there is no margin in the capacity of the storage device 4. In a case where the capacity of the storage device 4 has a margin, the expiration date need not be set.

In addition, the event consumer 31 may output the media information file name to the storage device 4 in order to delete the media information for which the authenticity determination has been completed from the storage device 4. Upon acquiring the media information file name, the storage device 4 deletes the media information stored with the media information file name acquired from the posted media file group 421. The deletion of the media information is useful, for example, when there is no margin in the capacity of the storage device 4. In a case where there is a margin in the capacity of the storage device 4, the media information need not be deleted.
(14A) The event consumer 31 outputs, to the RDB 41 of the storage device 4, the authenticity determination event ID of the authenticity determination event for which the processing of authenticity determination has been completed with information indicating completion such as a completion flag added thereto as information notifying that the state of the authenticity determination event that has been processed by the event consumer itself has been completed, and outputs the event consumer ID of the event consumer as the event consumer who has performed the processing. The RDB 41 registers, in the queue table 413, the authenticity determination event ID already registered, the acquired information indicating completion, and its own event consumer ID of the event consumer who has performed the processing of authenticity determination in association with one another.
(15A) The event consumer 31 determines whether or not all the authenticity determination events older than the authenticity determination event that the event consumer itself processed last have been completed, and when determining that all the authenticity determination events have been completed, the event consumer outputs information indicating that the latest continuous completion authenticity determination event ID should be set to the authenticity determination event ID that the event consumer processed last to the RDB 41 of the storage device 4. The RDB 41 updates the latest continuous completion authenticity determination event ID on the basis of the acquired information.
(16A) When the determination in the processing step (15A) is a determination that all the events have not been completed, that is, a determination that there is an incomplete authenticity determination event, the event consumer 31 outputs, to the RDB 41 of the storage device 4, information indicating that the latest continuous completion authenticity determination event ID should be set as the authenticity determination event ID of the latest authenticity determination event among the authenticity determination events for which the processing has been completed.
(17A) After being on standby for a predetermined time, the event consumer 31 returns to the processing step (2A) and repeats the processing.

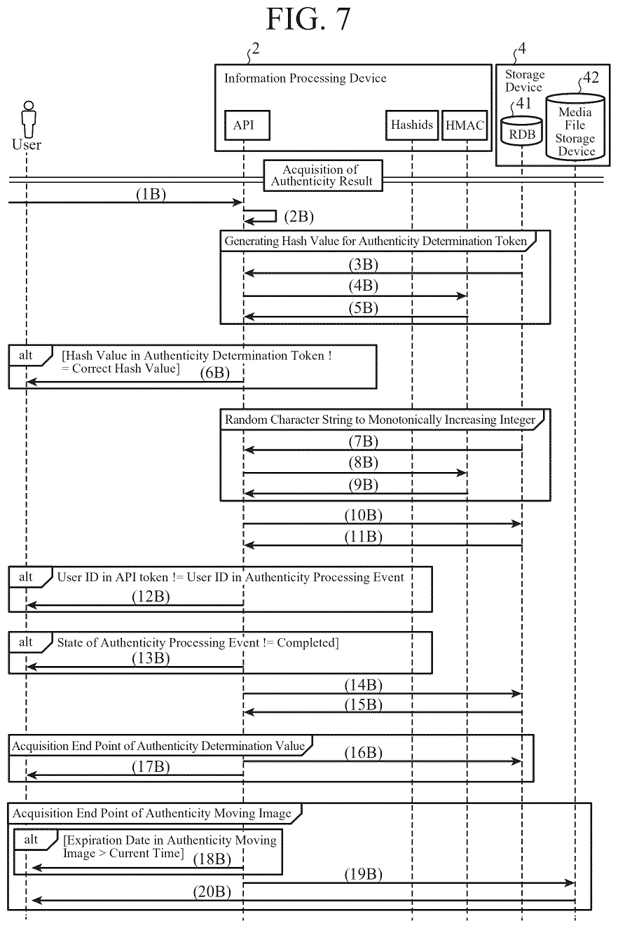

FIG. 7 is a sequence diagram illustrating processing at the time of transmission and reception of a product of authenticity determination of the information processing system according to the first embodiment. FIG. 7 illustrates a more specific example of processing at the time of transmission and reception of a product of authenticity determination in the information processing system 1. “Hashids”, “HMAC”, and “user” in FIG. 7 are premises similar to those described for FIG. 5.

Hereinafter, each of the processing steps (1B) to (20B) in FIG. 7 will be described in order.
(1B) The user (external terminal 5) transmits a product request describing the API token and the authenticity determination token to the API (for example, the product acquiring unit 224) of the information processing device 2.
(2B) The API (for example, the product acquiring unit 224) of the information processing device 2 performs authentication processing of the user on the basis of the API token.
(3B) The API (for example, the product acquiring unit 224) of the information processing device 2 acquires the authenticity determination token password associated with the user ID and the like obtained from the API token from the RDB 41 of the storage device 4.
(4B) The API (for example, the product acquiring unit 224) of the information processing device 2 sets the authenticity determination token password acquired in the processing step (3B) and the public authenticity determination event ID included in the authenticity determination token transmitted from the user (external terminal 5) in the processing step (1B) to the HMAC.
(5B) The HMAC generates a second hash value on the basis of the authenticity determination token password and a publishing determination event ID set in the processing step (4B), and returns the second hash value as a correct hash value to the API of the information processing device 2.
(6B) The API (for example, the product acquiring unit 224) of the information processing device 2 determines whether or not the hash value included in the authenticity determination token described in the product request and the correct hash value (second hash value) are the same values, and transmits a response indicating a processing error to the user (external terminal 5) as a response to the product request when it is determined that the hash value and the correct hash value are not the same values. Here, if the hash value included in the authenticity determination token described in the product request is the first hash value generated in the processing step (12) of FIG. 5 and included in the authenticity determination token in the processing step (13), and the public authenticity determination event ID included in the authenticity determination token described in the product request has been used for generating the first hash value, the hash value included in the authenticity determination token described in the product request and the correct hash value are the same values. On the other hand, when the authenticity determination token described in the product request is invalid due to falsification or the like, the hash value included in the authenticity determination token described in the product request and the correct hash value are different values.
(7B) When the API (for example, the product acquiring unit 224) of the information processing device 2 determines that the hash value included in the authenticity determination token described in the product request and the correct hash value are the same values in the determination of the processing step (6B), the API acquires the public authenticity determination event ID seed associated with the user ID and the like obtained from the API token from the RDB 41 of the storage device 4.
(8B) The API (for example, the product acquiring unit 224) of the information processing device 2 sets the public authenticity determination event ID seed to Hashids as a character string (salt) to be used for decoding the public authenticity determination event ID included in the authenticity determination token described in the product request.
(9B) The Hashids returns the integer value obtained by decoding the public authenticity determination event ID to the API of the information processing device 2 as the authenticity determination event ID.
(10B) The API (for example, the product acquiring unit 224) of the information processing device 2 outputs the authenticity determination event ID obtained by decoding to the RDB 41 of the storage device 4, and requests transmission of the authenticity determination event information associated with the authenticity determination event ID.
(11B) The API (for example, the product acquiring unit 224) of the information processing device 2 acquires the authenticity determination event information associated with the authenticity determination event ID obtained by decoding from the RDB 41 of the storage device 4.
(12B) The API (for example, the product acquiring unit 224) of the information processing device 2 determines whether or not the user ID obtained from the API token described in the product request is the same as the user ID obtained on the basis of the authenticity determination event information, and transmits a response indicating a processing error to the user (external terminal 5) when it is determined that the user ID is not the same.

Note that, for example, when the product acquiring unit 224 performs the processing of the processing steps (2B) to (12B), the product acquiring unit 224 needs to use registration information in the user table 411 or the queue table 413, but in FIG. 1, a connection line between the product acquiring unit 224 and the user table 411 or the queue table 413 is omitted.
(13B) When it is determined that both the user IDs are the same in the determination of the processing step (12B), next, the API (for example, the product acquiring unit 224) of the information processing device 2 determines whether or not the processing of authenticity determination for the authenticity determination event indicated by the authenticity determination event ID is completed, and when it is determined that the processing is not completed, a response indicating an error indicating that the processing is still in progress is transmitted to the user (external terminal 5).
(14B) When it is determined that the processing has been completed in the determination of whether or not the processing of the processing step (13B) has been completed, the API (for example, the product acquiring unit 224) of the information processing device 2 outputs the authenticity determination event ID to the RDB 41 of the storage device 4 and requests a product of the authenticity determination of the authenticity determination event indicated by the authenticity determination event ID.
(15B) The API (for example, the product acquiring unit 224) of the information processing device 2 acquires the authenticity determination value from the RDB 41 of the storage device 4 as the product of the authenticity determination of the authenticity determination event indicated by the authenticity determination event ID.
(16B) The API (for example, the product acquiring unit 224) of the information processing device 2 determines whether or not the end point described in the product request requests transmission of the authenticity determination value, and outputs the authenticity determination event ID to the RDB 41 of the storage device 4 again when it is determined that the end point requests transmission of the authenticity determination value.
(17B) The API (for example, the product acquiring unit 224) of the information processing device 2 acquires the authenticity determination value from the RDB 41 of the storage device 4 as the product of the authenticity determination of the authenticity determination event indicated by the authenticity determination event ID. More specifically, the API of the information processing device 2 acquires the above-described authenticity determination value from the determination result table 412 of the RDB 41.

Note that the processing of the processing steps (14B) to (15B) partially overlaps the processing of the processing steps (16B) to (17B), and thus can be omitted.
(18B) When it is determined that the end point does not request transmission of the authenticity determination value in the determination of the end point in the processing step (16B), the API (for example, the product acquiring unit 224) of the information processing device 2 determines that the end point requests transmission of the processed media information.

Next, the API of the information processing device 2 determines whether or not there is a request for generating a processed media file, and when it is determined that there is no request for generating a processed media file, a response indicating an error indicating that there is no request for generating a processed media file is transmitted to the user (external terminal 5).

Further, the API of the information processing device 2 further determines whether or not the expiration date of the processed media information is later than the current time, and transmits a response indicating an error indicating that the expiration date is expired to the user (external terminal 5) when it is determined that the expiration date is earlier than the current time.
(19B) When it is determined that the expiration date of the processed media information is later than the current time, the API (for example, the product acquiring unit 224) of the information processing device 2 outputs a file name of the processed media information to the media file storage device 42 of the storage device 4.
(20B) The API (for example, the product acquiring unit 224) of the information processing device 2 acquires the processed media information from the media file storage device 42 of the storage device 4. Then, the API (for example, the product transmitting unit 225) of the information processing device 2 transmits the acquired processed media information to the user (external terminal 5).

So far, the case where the information processing system 1 does not include the auxiliary information processing device 6 has been mainly described. Hereinafter, a case where the information processing system 1 includes the auxiliary information processing device 6 will be described.

As described above, the information processing system 1 may include at least the information processing device 2, the inference device 3, the storage device 4, the external terminal 5, and the auxiliary information processing device 6. The information processing system 1 in this case performs authenticity determination on the media information acquired from the external terminal 5, indicating whether or not the media information is generated by AI, and transmits a product of the authenticity determination to the auxiliary information processing device 6, and the auxiliary information processing device 6 transmits information corresponding to the product of the authenticity determination to the external terminal 5.

In a case where the information processing system 1 includes the auxiliary information processing device 6, the operation of the product transmitting unit 225 is changed as compared with the case where the information processing system 1 does not include the auxiliary information processing device 6.

In a case where the information processing system 1 includes the auxiliary information processing device 6, when the product acquiring unit 224 acquires a product of authenticity determination on the basis of the product request, the product transmitting unit 225 transmits the product of authenticity determination to the auxiliary information processing device 6 via the communication unit 21.

Upon receiving the product of the authenticity determination, the auxiliary information processing device 6 generates information corresponding to the product of the authenticity determination as described above, and outputs the generated information corresponding to the product of the authenticity determination to the external terminal 5. At that time, the auxiliary information processing device 6 may output the product of the authenticity determination to the external terminal 5 in addition to the generated information corresponding to the product of the authenticity determination.

In addition, when the product acquiring unit 224 acquires a product of authenticity determination, the product transmitting unit 225 may transmit the product of authenticity determination to both the external terminal 5 and the auxiliary information processing device 6 via the communication unit 21. Also in this case, upon receiving the product of the authenticity determination, the auxiliary information processing device 6 generates information corresponding to the product of the authenticity determination as described above, and outputs the generated information corresponding to the product of the authenticity determination to the external terminal 5.

Although the case where the authenticity determination API is the Web API has been described above, the authenticity determination API is not limited to the Web API. That is, a request such as a posting request that can be received by the information processing device 2 is not limited to a request or the like described in accordance with the HTTP, and the information processing device 2 may provide an API capable of receiving a request or the like generated using any program language.

In addition, in the processing at the time of posting the media information, the processing at the time of authenticity determination, and the processing at the time of transmitting and receiving a product of authenticity determination in the information processing system 1, which are described with reference to FIGS. 5 to 7, which information is managed by assigning an ID and the like, or a mechanism for guaranteeing integrity and the like may be changed as necessary. For example, a unique ID may be assigned to each of the media information, the processed media information, and the authenticity determination value, and management using the ID may be performed. In addition, for example, when information such as a media information file name or a processed media information file name is exchanged between devices in the information processing system 1, a mechanism of integrity guarantee using Hashid or HMAC may be introduced.

Further, in the process at the time of transmitting and receiving the product of the authenticity determination in the information processing system 1, described with reference to FIG. 7, the API of the information processing device 2 determines, as the processing of the processing step (13B), whether or not the processing of authenticity determination of the authenticity determination event indicated by the authenticity determination event ID is completed, and transmits a response indicating an error indicating that the processing is still in progress to the user (external terminal 5) when it is determined that the processing is not completed.

In addition to a response based on the determination as to whether or not the processing of authenticity determination in the processing step (13B) described above is completed when the API of the information processing device 2 receives the product request, the API (for example, the product acquiring unit 224) of the information processing device 2 may receive a processing status confirmation request different from the product request from the external terminal 5.

The processing status confirmation request requests transmission of information regarding a processing state of authenticity determination for the media information posted by the posting request, and is described in accordance with, for example, HTTP. Specifically, the processing status confirmation request is described using, for example, the GET method. In the processing status confirmation request, in addition to the authenticity determination token, an API token may also be described. In a case where the API token is described in the processing status confirmation request, upon acquiring the processing status confirmation request from the external terminal 5, the API (for example, the product acquiring unit 224) of the information processing device 2 performs authentication processing of the user on the basis of the API token, and then, acquires information regarding a processing state of authenticity determination for media information specified by the authenticity determination token from the queue table 413.

When the information processing device 2 acquires the information regarding the processing state of authenticity determination, the API (for example, the product transmitting unit 225) of the information processing device 2 transmits the acquired information regarding the processing state of the authenticity determination to the external terminal 5.

The information processing system 1 can also be used in an electronic know your customer (eKYC). In eKYC, identity verification is performed using an image of a face transmitted from a mobile terminal or the like, but in recent years, there is a concern about an act of illegally attempting to succeed in identity verification using an image of a face generated by AI.

On the other hand, for example, the authenticity determination can be performed on the face image transmitted from the mobile terminal or the like to an eKYC server using the authenticity determination function provided by the information processing system 1.

In this case, for example, the eKYC server is used as the external terminal 5. When acquiring a face image from a mobile terminal or the like, the eKYC server transmits a posting request with the face image as media information to the information processing device 2, and receives the authenticity determination token from the information processing device 2. Thereafter, the eKYC server transmits a product request in which the authenticity determination token is described to the information processing device 2 at a timing according to the needs, and receives, for example, the authenticity determination value as a product of the authenticity determination transmitted from the information processing device 2. The eKYC server uses the authenticity determination value to determine whether or not the identity verification is successful, and transmits the result of the identity verification to a mobile terminal or the like.

Alternatively, after the eKYC server transmits the product request in which the authenticity determination token is described to the information processing device 2 at the timing according to the needs as described above, the information processing device 2 may transmit, for example, the authenticity determination value to the auxiliary information processing device 6 instead of the eKYC server as the product of the authenticity determination. The auxiliary information processing device 6 uses the authenticity determination value to determine whether or not the identity verification is successful, and transmits a result of the identity verification to a mobile terminal or the like.

As described above, the information processing device 2 according to the first embodiment includes: the media information acquiring unit 221 to receive a posting request from the external terminal 5 and acquire media information designated by the posting request; the output unit 222 to output the media information to the storage device 4 accessible from the inference device 3 that performs authenticity determination indicating whether or not the media information is generated by AI; and the token transmitting unit 223 to transmit, to the external terminal 5, an authenticity token for the external terminal 5 to acquire a product of the authenticity determination on the media information generated by the inference device 3.

Thus, the user who desires to perform authenticity determination of certain media information performs an operation of causing the information processing device 2 to acquire the media information using the external terminal 5, thereby being able to obtain the authenticity determination token for the external terminal 5 to acquire the product of authenticity determination for the media information. Therefore, the information processing device 2 according to the present invention can provide the authenticity determination function of the media information to the user by a highly convenient method.

The information processing device 2 according to the first embodiment further includes the product acquiring unit 224 that receives a product request in which an authenticity determination token is described from the external terminal 5 and acquires a product of authenticity determination identified by the authenticity determination token from the storage device 4, and the product transmitting unit 225 that transmits the product of authenticity determination to the external terminal 5.

Thus, the information processing device 2 according to the first embodiment can transmit the product of the authenticity determination to the external terminal 5 at the timing of receiving the authenticity determination token. Since the user can request the product of the authenticity determination by using the authenticity determination token at any timing desired by the user as long as it is a timing at which a product of the authenticity determination by the inference device 3 is obtained, the convenience for the user is high.

In the information processing device 2 according to the first embodiment, the media information acquiring unit 221 may receive a posting request described in accordance with HTTP, and the product acquiring unit 224 may receive a product request described in accordance with HTTP.

Thus, the information processing device 2 according to the first embodiment can provide the authenticity determination function via the Web API, which is highly convenient for the user.

In the information processing device 2 according to the first embodiment, the product acquiring unit 224 acquires the authenticity determination value as a product of authenticity determination.

Thus, the information processing device 2 according to the first embodiment can acquire and transmit the product of the authenticity determination to the external terminal 5 as the authenticity determination value, which is rather small information. Further, it is possible for the user to obtain a product of authenticity determination as information such as numbers or characters, and thus processing of the product is easy and convenience is high.

In the information processing device 2 according to the first embodiment, in a case where the media information is a moving image, the authenticity determination value is at least one of: a frame number of a frame generated by AI, an elapsed time indicating a moving image portion generated by AI, a moving image authenticity determination score indicating a result of authenticity determination by a numerical value, a threshold for distinguishing authenticity on the basis of the moving image authenticity determination score, coordinates indicating an image portion generated by AI in one frame, an authenticity determination result as the entire moving image indicated binarily, or indexes indicating a plurality of respective targets in a case where there is the plurality of targets for authenticity determination and the moving image authenticity determination score for each of the indexes.

Further, in a case where the media information is a still image, the authenticity determination value is at least one of: a still image authenticity determination score indicating a result of authenticity determination by a numerical value, a threshold for distinguishing authenticity on the basis of the still image authenticity determination score, coordinates indicating an image portion generated by AI in the still image, an authenticity determination result of the entire still image indicated binarily, or indexes indicating a plurality of respective targets in a case where there is the plurality of targets for authenticity determination and the still image authenticity determination score for each of the indexes.

Further, in a case where the media information is a voice, the authenticity determination value is at least one of: a voice authenticity determination score indicating a result of authenticity determination by a numerical value, a threshold for distinguishing authenticity on the basis of the voice authenticity determination score, a frequency domain of the voice generated by AI, or a time domain of the voice generated by AI.

Further, in a case where the media information is a text, the authenticity determination value is at least one of: a text authenticity determination score indicating a result of authenticity determination by a numerical value, a threshold for distinguishing authenticity on the basis of the text authenticity determination score, or a position generated by AI in the text.

Thus, the information processing device 2 according to the first embodiment can transmit the authenticity determination value corresponding to the type of the media information to the external terminal 5, which is highly convenient for the user who handles various types of media information.

In the information processing device 2 according to the first embodiment, the product acquiring unit 224 acquires, as a product of authenticity determination, processed media information in which information indicating a result of authenticity determination is added to media information.

Thus, the information processing device 2 according to the first embodiment can transmit, to the external terminal 5 in response to a request from the external terminal 5, the processed media information in which the information portion generated by AI in the media information can be confirmed through perception such as visual perception, which is highly convenient for the user.

In the information processing device 2 according to the first embodiment, the output unit 222 outputs the generation request information to the storage device 4 in addition to the media information in a case where the generation request information for requesting generation of the processed media information is described in the posting request, and the product acquiring unit 224 acquires the processed media information as a product of the authenticity determination when receiving the product request which is described in accordance with the HTTP and in which the authenticity determination token and the transmission request of the processed media information are described from the external terminal 5.

Thus, the information processing device 2 according to the first embodiment can cause the inference device 3 to generate the processed media information only in a case where there is a processed media information generation request from the external terminal 5, and thus it is possible to reduce an unnecessary load on the inference device 3 and save the capacity of the storage device 4. Further, as a result of reducing an unnecessary load, the processing by the inference device 3 becomes efficient, and thus the user can efficiently obtain the product of the authenticity determination, which is highly convenient for the user.

The information processing device 2 according to the first embodiment may include the product acquiring unit 224 that receives a product request in which an authenticity determination token is described from the external terminal 5 and acquires a product of authenticity determination identified by the authenticity determination token from the storage device 4, and the product transmitting unit 225 that transmits the product of authenticity determination to the auxiliary information processing device 6 that transmits information corresponding to the product of authenticity determination to the external terminal.

Thus, the information processing device 2 according to the first embodiment can add additional information to the product of authenticity determination that can be provided to the external terminal 5 using the information processing device 2, and thus it is possible to increase the number of types of information that can be acquired by the user, which is highly convenient for the user.

The information processing system 1 according to the first embodiment includes the information processing device 2, the inference device 3, the storage device 4, and the external terminal 5.

Thus, the information processing system 1 according to the first embodiment can provide the authenticity determination function of the media information to the user by a highly convenient method.

The information processing system 1 according to the first embodiment may include the information processing device 2, the inference device 3, the storage device 4, the external terminal 5, and the auxiliary information processing device 6.

Thus, in the information processing system 1 according to the first embodiment, the information processing system 1 according to the first embodiment can provide the authenticity determination function of the media information to the user by a highly convenient method.

Since the program according to the first embodiment causes a computer to function as the information processing device 2, the program according to the first embodiment can cause the computer to function as the information processing device 2 capable of providing the authenticity determination function of the media information to the user by a highly convenient method.

The information processing method according to the first embodiment includes the steps of: by the media information acquiring unit 221, receiving, a posting request from an external terminal and acquiring media information designated by the posting request; by the output unit 222, outputting the media information to a storage device 4 accessible by the inference device 3 that performs authenticity determination on the media information; and by the token transmitting unit 223, transmitting an authenticity determination token for the external terminal 5 to acquire a product of the authenticity determination on the media information generated by the inference device 3 to the external terminal 5.

Thus, the information processing method according to the first embodiment can provide the authenticity determination function of media information to a user by a highly convenient method.

### INDUSTRIAL APPLICABILITY

For example, an information processing device according to the present invention can provide an authenticity determination function of media information to a user by a highly convenient method.

### REFERENCE SIGNS LIST

1: information processing system, 2: information processing device, 3: inference device, 4: storage device, 5: external terminal, 6: auxiliary information processing device, 21: communication unit, 22: calculation unit, 31: event consumer, 32: inference unit, 41: RDB, 42: media file storage device, 221: media information acquiring unit, 222: output unit, 223: token transmitting unit, 224: product acquiring unit, 225: product transmitting unit, 411: user table, 412: determination result table, 413: queue table, 421: posted media file group, 422: processed media file group

1-12. (canceled)

13. An information processing method comprising:
receiving a posting request from an external terminal and acquiring media information designated by the posting request; and
transmitting to the external terminal an authenticity determination token for the external terminal to acquire a product of the authenticity determination on the media information generated by an inference process in which the authenticity determination is performed on the media information.

14. The information processing method according to claim 13, further comprising:
outputting the media information to a storage device accessible from an inference device that performs the inference process.

15. The information processing method according to claim 13, further comprising:
generating the authenticity determination token in association with the inference process for the authenticity determination.

16. The information processing method according to claim 14, further comprising:
receiving a product request in which the authenticity determination token is described from the external terminal, and acquiring the product of the authenticity determination identified by the authenticity determination token from the storage device; and
transmitting the product of the authenticity determination to the external terminal.

17. The information processing method according to claim 16, wherein
the posting request and the product request are described in accordance with HTTP.

18. The information processing method according to claim 13, wherein
the product of the authenticity determination includes an authenticity determination value indicating a result of the authenticity determination by a numerical value or a character.

19. The information processing method according to claim 18, wherein
in a case where the media information is a moving image, the authenticity determination value is at least one of: a frame number of a frame generated by AI, an elapsed time indicating a moving image portion generated by AI, a moving image authenticity determination score indicating a result of authenticity determination by a numerical value, a threshold for distinguishing authenticity on a basis of the moving image authenticity determination score, coordinates indicating an image portion generated by AI in one frame, an authenticity determination result as the entire moving image indicated binarily, or indexes indicating a plurality of respective targets in a case where there is the plurality of targets for authenticity determination and the moving image authenticity determination score for each of the indexes,
in a case where the media information is a still image, the authenticity determination value is at least one of: a still image authenticity determination score indicating a result of authenticity determination by a numerical value, a threshold for distinguishing authenticity on a basis of the still image authenticity determination score, coordinates indicating an image portion generated by AI in the still image, an authenticity determination result of the entire still image indicated binarily, or indexes indicating a plurality of respective targets in a case where there is the plurality of targets for authenticity determination and the still image authenticity determination score for each of the indexes,
in a case where the media information is a voice, the authenticity determination value is at least one of: a voice authenticity determination score indicating a result of authenticity determination by a numerical value, a threshold for distinguishing authenticity on a basis of the voice authenticity determination score, a frequency domain of the voice generated by AI, or a time domain of the voice generated by AI, or
in a case where the media information is a text, the authenticity determination value is at least one of: a text authenticity determination score indicating a result of authenticity determination by a numerical value, a threshold for distinguishing authenticity on a basis of the text authenticity determination score, or a position generated by AI in the text.

20. The information processing method according to claim 13, wherein
acquiring, as the product of the authenticity determination, processed media information in which information indicating a result of the authenticity determination is added to the media information.

21. The information processing method according to claim 20, wherein
in a case where generation request information for requesting generation of the processed media information is described in the posting request, outputting the generation request information to a storage device in addition to the media information, and
upon receiving a product request in which the authenticity determination token and a transmission request of the processed media information are described from the external terminal, acquiring the processed media information as the product of the authenticity determination.

22. The information processing method according to claim 14, further comprising:
receiving a product request in which the authenticity determination token is described from the external terminal, and acquiring the product of the authenticity determination identified by the authenticity determination token from the storage device; and
transmitting the product of the authenticity determination to an auxiliary information processing device that transmits information corresponding to the product of the authenticity determination to the external terminal.

23. An information processing system comprising:
a processor to execute a program; and
a memory to store the program which, when executed by the processor, performs processes of:
receiving a posting request from an external terminal and acquiring media information designated by the posting request;
outputting the media information to a storage device accessible from an inference device that performs authenticity determination indicating whether or not the media information is generated by AI; and
transmitting to the external terminal an authenticity determination token for the external terminal to acquire a product of the authenticity determination on the media information generated by the inference device.

24. The information processing system according to claim 23, further comprising:
the inference device;
the storage device; and
the external terminal.

25. A non-transitory computer-readable storage medium storing a program for causing a computer to perform the information processing method according to claim 13.

26. An information processing method comprising:
transmitting a posting request to an information processing device to enable acquisition of media information designated by the posting request; and
receiving in response to the transmitted posting request, from the information processing device, an authenticity determination token for acquiring a product of authenticity determination on the media information.

27. The information processing method according to claim 26, further comprising:
acquiring, from the information processing device, the product of the authenticity determination on the media information, generated by an inference process in which the authenticity determination is performed on the media information.
